(19) United States
(12) Patent Application Publication
(10) Pub. No.: US 2023/0262049 A1
(43) Pub. Date: Aug. 17, 2023

(54) CYBERATTACK RESISTANT COMPUTING SYSTEM AND METHOD

(71) Applicant: Dark Cryptonite, LLC, New York, NY (US)

(72) Inventors: Tyler Cohen Wood, Fort Worth, TX (US); Robert Schiff, New York, NY (US); Kenneth John Muir

(21) Appl. No.: 18/170,231

(22) Filed: Feb. 16, 2023

Related U.S. Application Data
(60) Provisional application No. 63/310,904, filed on Feb. 16, 2022.

(51) Int. Cl. H04L 9/40

(52) U.S. Cl. CPC H04L 63/083; H04L 63/0421

(57) ABSTRACT

A system for providing secure data storage, data transfer, and communication, the system communicably coupled with a global communications network, comprises a data repository configured for accessing an external overlay network consisting of a network of volunteer nodes that utilize onion routing to send and receive data, wherein the data repository is further configured for storing data and applications belonging to users, a database management system configured for: 1) accessing the overlay network; 2) controlling user access to the data repository via the overlay network, and 3) sending and receiving data via the overlay network using onion routing, and a client application configured for: 1) controlling user access to the client application by requiring security credentials; 2) accessing the overlay network over the global communications network, and 3) sending and receiving data via the overlay network using onion routing.

### CROSS-REFERENCE TO RELATED APPLICATIONS

This patent application claims priority to provisional Pat. Application No. 63310904 filed on Feb. 16, 2022. The contents of provisional patent application number 63310904 are hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of cybersecurity and, more specifically, the claimed subject matter relates to the field of computing systems and methods that are resistant to cyberattacks.

### BACKGROUND

A cyberattack is any offensive maneuver that targets computer information systems, computer networks, infrastructures, personal computer or any device. An attacker is a person or process that attempts to access data, functions, or other restricted areas of the system without authorization, potentially with malicious intent. A cyberattack can be employed by sovereign states, individuals, groups, society, or organizations, and it may originate from an anonymous source. A cyberattack may steal, alter, or destroy a specified target by hacking into a susceptible system. Cyberattacks can range from installing spyware on a personal computer to attempting to destroy the infrastructure of a computer system to holding important data hostage in exchange for a ransom, i.e., a ransomware attack.

Cyberattacks have become increasingly sophisticated and dangerous. Additionally, the number of cyberattacks worldwide has increased. At the same time, losses stemming from cyberattacks are also increasing. While new networks are being rolled out and existing networks are being expanded, these networks are increasingly becoming vulnerable to cyber threats. Furthermore, many companies today have implemented work-from-home policies in the wake of the outbreak of the COVID-19 pandemic, and this operational change has exposed information technology (IT) infrastructures to vulnerabilities, particularly due to the increased use of cloud services. The risk is particularly significant for the public and private sectors, i.e. government agencies, healthcare providers, financial institutions, managed service providers, airlines, pharmaceutical companies, manufacturing units, IT and software companies, critical infrastructure, and for individual consumers, thereby driving the need for changing security delivery models. As such, the ongoing pandemic is expected to encourage enterprises to assess their IT infrastructure and opt for more robust cybersecurity services.

Therefore, what is needed is a system and method for improving the problems with the prior art, and more particularly for a more expedient and efficient method and system for making computing systems resistant to cyberattacks.

### BRIEF SUMMARY

In one embodiment, a cyberattack resistant computing system and method is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claim subject matter’s scope.

In one embodiment, a cyberattack resistant computing system on a communications network is disclosed. The system for providing secure data storage, data transfer, and communication, the system communicably coupled with a global communications network, comprises a data repository communicably coupled with the global communications network, the data repository configured for accessing an external overlay network consisting of a network of volunteer nodes that utilize onion routing to send and receive data, wherein the data repository is further configured for storing data and applications belonging to users, a database management system communicably coupled with the global communications network, the database management system configured for: 1) accessing the overlay network; 2) controlling user access to the data repository via the overlay network, and 3) sending and receiving data via the overlay network using onion routing, and a client application executing on a user computing device coupled with the global communications network, the client application configured for: 1) controlling user access to the client application by requiring security credentials; 2) accessing the overlay network over the global communications network, and 3) sending and receiving data via the overlay network using onion routing.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a cyberattack resistant computing system and method connected to a communications network, in accordance with one embodiment.

FIG. 2 is a block diagram illustrating additional details about the network architecture of the cyberattack resistant computing system and method connected to a communications network, in accordance with one embodiment.

FIG. 3 is a flow chart depicting the general control flow of a process of a cyberattack resistant computing system and method connected to a communications network, according to one embodiment.

FIG. 4 is a block diagram depicting a system including an example computing device and other computing devices.

### DETAILED DESCRIPTION

It should be understood that the embodiments disclosed herein are only examples of the many advantageous uses of the innovative teachings of the claimed embodiments. In general, statements made in the specification of the present application do not necessarily limit any of the various claimed embodiments. Moreover, some statements may apply to some inventive features but not to others. In general, unless otherwise indicated, singular elements may be in the plural and vice versa with no loss of generality. In the drawing like numerals refer to like parts through several views.

The disclosed embodiments improve upon the problems with the prior art by providing a system and method that reduces or eliminates cyberattacks on a data storage and communications system. The disclosed embodiments provide multiple protective measures that prevent cyberattacks, which results in a safer and more usable data storage and communications system. Therefore, the disclosed embodiments provide a data storage and communications system that can be used in multiple different implementations, such as colocation facilities, cloud data services, etc. This is advantageous for users, as it provides greater flexibility and a safer and more secure data storage and communications system. An additional benefit of the disclosed embodiments is the physical protection of data, as the disclosed embodiments require a physically secure bunker. The main benefit of the claimed subject matter is an improvement in safety and security of conventional data storage and communications systems.

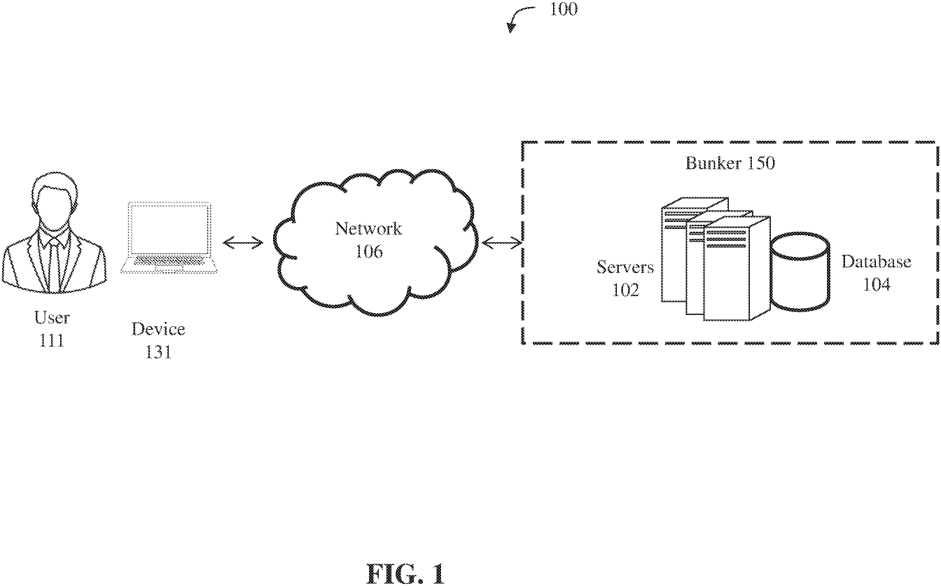

Referring now to the drawing figures in which like reference designators refer to like elements, there is shown in FIG. 1 an illustration of a block diagram showing the network architecture of a cyberattack resistant system 100 and method on a communications network in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, a cyberattack resistant computing system and method.

FIG. 1 includes mobile computing device 131, which may be smart phones, mobile phones, tablet computers, handheld computers, laptops, or the like. In another embodiment, mobile computing device 131 may be workstations, desktop computers, servers, laptops, all-in-one computers, or the like. In another embodiment, mobile computing device 131 may be AR or VR systems that may include display screens, headsets, heads up displays, helmet mounted display screens, tracking devices, tracking lighthouses or the like. Mobile computing device 131 corresponds to a user 111 of the cyberattack resistant system and method 100. FIG. 1 also shows one or more server 102 corresponding to a fortified bunker 150 that provides a cyberattack resistant system and method. Devices 131, 201 and 102 may be communicatively coupled with network 106 in a wired or wireless fashion. Augmented reality (AR) adds digital elements to a live view often by using a camera on a computing device. Virtual reality (VR) is a complete or near complete immersion experience that replaces the physical world.

FIG. 1 further shows that server 102 includes a database or repository 104, which may be a database controlled by a database management system. Devices 131, 201 may also each include their own database. The repository 104 serves data from a database, which is a repository for data used by server 102 and devices 131, 201 during the course of operation of the disclosed embodiments. Database 104 may be distributed over one or more nodes or locations that are connected via network 106. The database 104, or data repository, is configured for accessing an external overlay network (108) consisting of a network of volunteer nodes that utilize onion routing to send and receive data, wherein the data repository is further configured for storing data and applications belonging to users.

The database 104 may include a user record for each user 111. A user record may include: contact/identifying information for the user (name, address, telephone number(s), email address, etc.), information pertaining to IP addresses associated with the user, electronic payment information for the user, information pertaining to the purchases made by the user, sales transaction data associated with the user, file permissions, etc. A user record may also include a unique identifier for each user, a residential address for each user, the current location of each user (based on location-based services from the user’s mobile computer) and a description of past IP addresses utilized by each user.

Sales transaction data may include one or more product/service identifiers (such as SKUs), one or more product/service amounts, buyer contact/identifying information, brick and mortar outlet information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may include a document management system (DMS), which is a computerized system used to store, share, track and manage files or documents. The document management system may also provide storage, versioning, metadata, security, as well as indexing and retrieval capabilities for files and documents. The database 104 may also include a database management system communicably coupled with the global communications network 106, wherein the database management system is configured for: 1) accessing the overlay network 108; 2) controlling user access to the data repository 104 via the overlay network 108, and 3) sending and receiving data via the overlay network using onion routing.

FIG. 1 shows an embodiment wherein networked computing devices 131, 201 interact with server 102 and repository 104 over the network 106. It should be noted that although FIG. 1 shows only the networked computers 131, 201 and 102, the system of the disclosed embodiments supports any number of networked computing devices connected via network 106. Further, server 102, and units 131, 201 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 131, 201. Further, server 102 and its functionality, according to a preferred embodiment, can be realized in a centralized fashion in one computer system or in a distributed fashion wherein different elements are spread across several interconnected computer systems. Note that although FIG. 1 shows only one user 111 and one device 131, in one embodiment, the claimed embodiments support any number of users and devices connected via network 106.

The system of FIG. 1 may also include a payment authority, which acts to effectuate payments by user 111 for usage of the system, or the like. In the course of a sales transaction, server 102 may interface with payment authority to effectuate payment. In one embodiment, the payment authority is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc.

FIG. 1 also shows a bunker 150, which represents the physical presence of a building or other structure, which houses server 102 and database 104. Bunker 150 may be a concrete structure, partly dug into the ground, with the purpose of protecting valued materials. Bunker 150 may be a fortified enclosure in which defense is facilitated by concrete walls that work as protection. Bunker 150 may be located underground and may comprise an independent electrical source. Bunker 150 may be a colocation center or a type of data center where equipment, space, and bandwidth are available to the system 100. Colocation facilities provide space, power, cooling, and physical security for servers, storage, and networking equipment and also connect them to a variety of telecommunications and network service providers.

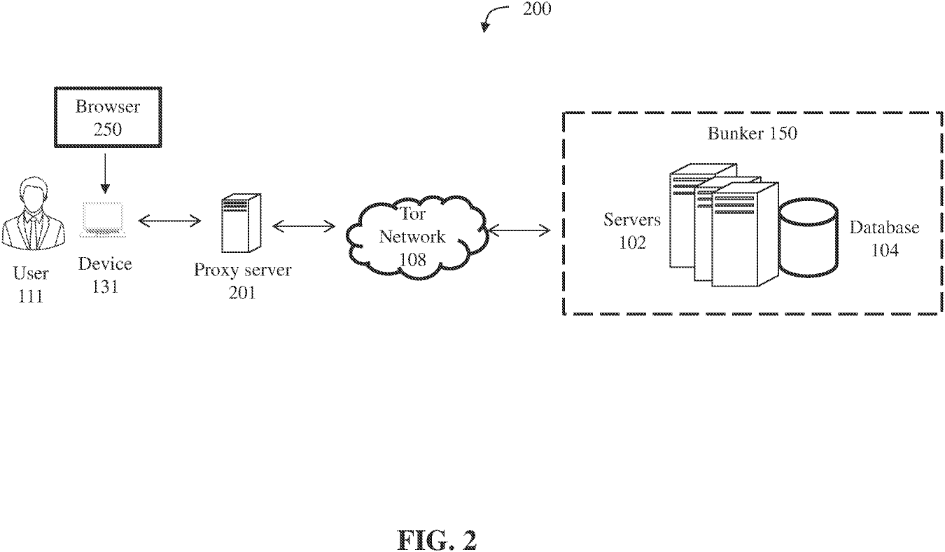

FIG. 2 is a block diagram 200 illustrating additional details about the network architecture of the cyberattack resistant computing system 100 and method connected to a global communications network 106, in accordance with one embodiment. FIG. 2 shows that the user 111 utilizes his device 131 to execute a special browser 250 to access a proxy server 201, which is then used to access the tor network 108, via which the server 102 and database 104 are accessed. The browser 250 is a client application for accessing the server 102 and database 104. When the user 111 requests data or services from the server 102 and database 104, the browser retrieves said data or services and then displays the data or services on the user’s screen. The purpose of the browser 250 is to fetch content or services from 102, 104 and display it on the device 131. This process begins when the browser 250 uses a hashed address that does not use the regular Internet architecture to access the proxy server 201 via network 106. The server 102 and database 104 are configured to provide data storage services, data transfer services, and communications services. Hashing is an algorithm performed on data such as a file or message to produce a number called a hash (sometimes called a checksum). The hash is used to verify that data is not modified, tampered with, or corrupted. In other words, you can verify the data has maintained integrity.

The tor network 108 enables anonymous communication as it directs Internet traffic through a free, worldwide, volunteer overlay network for concealing a user’s location and usage and protecting the personal privacy of its users, as well as their freedom and ability to conduct confidential communication by keeping their Internet activities unmonitored. An overlay network is a virtual network of nodes and logical links, which are built on top of an existing network. The aim of an overlay network is to enable a new service or function without having to reconfigure the entire network design.

The tor network 108 uses onion routing, which is a technique for anonymous communication over a computer network. In an onion network, messages have multiple encrypted layers, like layers of an onion. The encrypted data is transmitted through a series of network nodes called onion routers, each of which “peels” away from a single layer, uncovering the data’s next destination. When the final layer is decrypted, the message arrives at its destination. The sender remains anonymous because each intermediary knows only the location of the immediately preceding and following nodes.

The tor network 108 can provide anonymity to websites and other servers. Servers configured to receive inbound connections only through the tor network are called onion services. Rather than revealing a server’s IP address (and thus its network location), an onion service is accessed through its onion address, via the claimed browser 250. The tor network recognizes these onion addresses by looking up their corresponding public keys and introduction points from a distributed hash table within the network. The tor network 108 can route data to and from onion services, even those hosted behind firewalls or network address translators (NAT), while preserving the anonymity of both parties. The claimed browser 250 is necessary to access these onion services.

Onion addresses are not actual DNS names, but with the appropriate proxy software installed, the claimed browser 250 can access sites with onion addresses by sending the request through the tor network 108.

The tor network 108 is decentralized by design and thus there is no direct readable list of all onion services. Because onion services route their traffic entirely through the tor network, connection to an onion service is encrypted end-to-end and not subject to eavesdropping. Onion services must be accessed from the claimed browser 250.

A proxy server 201 is a server application that acts as an intermediary between a client (browser 250) requesting a resource and the server (102) providing that resource. Instead of connecting directly to the tor network 108 or to server 102 that can fulfill a request for a resource, such as a file or web page, the client 250 directs the request to the proxy server 201, which evaluates the request and performs the required network transactions. This serves as a method to simplify or control the complexity of the request, or provide additional benefits such as load balancing, privacy, or security. Proxies add structure and encapsulation to distributed systems. A proxy server 201 thus functions on behalf of the client 250 when requesting service, potentially masking the true origin of the request to the network 108 and/or the resource server 102.

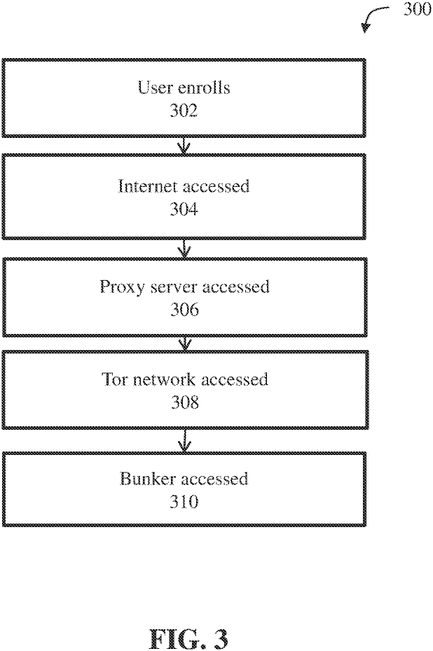

The process of a cyberattack resistant computing system and method connected to a communications network will now be described with reference to FIGS. 1-3 below. FIG. 3 depicts the control flow of the process for a cyberattack resistant computing system and method connected to a communications network 106, according to one embodiment. The process of the disclosed embodiments begins with optional step 302 (see flowchart 300), wherein the user 111 may enroll or register with server 102. In the course of enrolling or registering, the user may enter data into his device by manually entering data into an application via keyboard, keypad, touchpad, or via voice. In the course of enrolling or registering, the user may enter any data that may be stored in a user record, as defined above. Also in the course of enrolling or registering, the server 102 may generate a user record for each registering user and store the user record in an attached database, such as database 104.

In step 304, user 111 accesses the Internet or network 106 using the browser 250 on his device 131. The browser may restrict access to the browser by requiring credentials, such as a username and password.

In step 306, the user 111 accesses the proxy server 201 using browser 250 on his device 131. This process begins when the browser 250 uses a specific predefined IP address or Uniform Resource Locator (URL) to access the proxy server 201 via network 106. In one embodiment, the user 111 undergoes the process of authentication when accessing the proxy server 201, using credentials to log on to the proxy server 201. Authentication is the process of identifying a user who requests access to a system, network, or device. Credentials offer proof of a fact or of qualifications - an example of credentials includes a username and password authentication token that is bound to a particular user. In one embodiment, the user 111 undergoes the process of two-factor authentication when accessing the browser and/or proxy server 201. Two-factor authentication is an electronic authentication method in which a user is granted access to a system, network, or device only after successfully presenting two or more pieces of evidence or factors - such as a password or biometric such as a fingerprint or facial scan as well as a code sent by text to the user’s phone.

In step 308, the user 111 accesses the tor network 108 using the browser 250 on his device 131, via proxy server 201. In one embodiment, the user 111 undergoes the process of authentication when accessing the tor network 108, using credentials to log on to the tor network 108. In one embodiment, the user 111 undergoes the process of two-factor authentication when accessing the tor network 108.

In step 310, the user 111 accesses the data and services in database 104 and servers 102 using the browser 250 on his device 131, via proxy server 201. In one embodiment, the user 111 undergoes the process of authentication when accessing the server 102, using credentials to log on to the server 102. In one embodiment, the user 111 undergoes the process of two-factor authentication when accessing the server 102. Once logged on to the server 102, the bunker is now being accessed by the user 111.

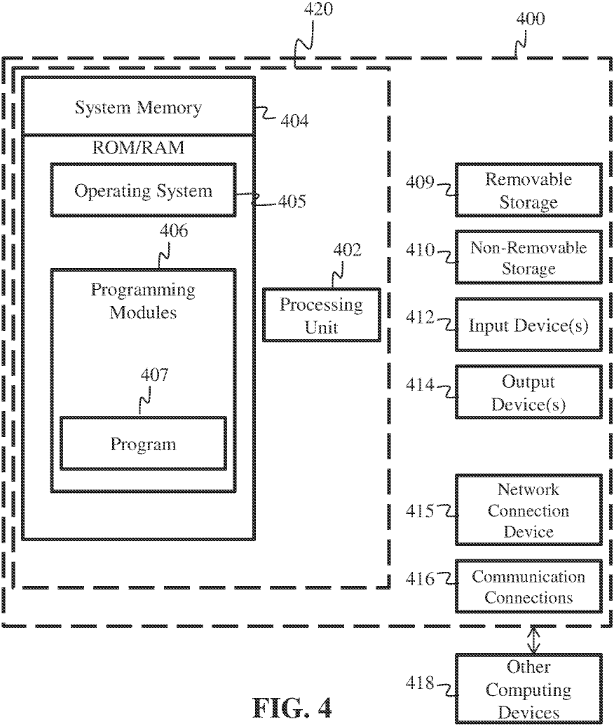

FIG. 4 is a block diagram of a system including an example computing device 400 and other computing devices. Consistent with the embodiments described herein, the aforementioned actions performed by 131, 201, 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400′s operation. In one embodiment, programming modules 406 may include, for example, a program module 407 for executing the actions of 131, 201, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods’ stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for providing secure data storage, data transfer, and communication, the system communicably coupled with a global communications network, the system comprising:
a) a data repository communicably coupled with the global communications network, the data repository configured for accessing an external overlay network consisting of a network of volunteer nodes that utilize onion routing to send and receive data, wherein the data repository is further configured for storing data and applications belonging to users;
b) a database management system communicably coupled with the global communications network, the database management system configured for: 1) accessing the overlay network; 2) controlling user access to the data repository via the overlay network, and 3) sending and receiving data via the overlay network using onion routing;
c) a client application executing on a user computing device coupled with the global communications network, the client application configured for: 1) controlling user access to the client application by requiring security credentials; 2) accessing the overlay network over the global communications network, and 3) sending and receiving data via the overlay network using onion routing.

2. The system of claim 1, wherein the step of accessing the overlay network comprises accessing a manual proxy server configured for accessing the overlay network.

3. The system of claim 2, wherein the step of accessing the manual proxy server comprises accessing a predefined server via the global communications network.

4. The system of claim 3, wherein security credentials comprise at least a username and password.

5. The system of claim 4, wherein the data repository is further configured for storing user records.

6. A method for providing secure data storage, data transfer, and communication over a global communications network, the method comprising:
a) providing a data repository communicably coupled with the global communications network, the data repository configured for accessing an external overlay network consisting of a network of volunteer nodes that utilize onion routing to send and receive data, wherein the data repository is further configured for storing data and applications belonging to users;
b) providing a database management system communicably coupled with the global communications network, the database management system configured for: 1) accessing the overlay network; 2) controlling user access to the data repository via the overlay network, and 3) sending and receiving data via the overlay network using onion routing; and
c) providing a client application executing on a user computing device coupled with the global communications network, the client application configured for: 1) controlling user access to the client application by requiring security credentials; 2) accessing the overlay network over the global communications network, and 3) sending and receiving data via the overlay network using onion routing.

7. The method of claim 6, wherein the step of accessing the overlay network comprises accessing a manual proxy server configured for accessing the overlay network.

8. The method of claim 7, wherein the step of accessing the manual proxy server comprises accessing a predefined server via the global communications network.

9. The method of claim 8, wherein security credentials comprise at least a username and password.

10. The method of claim 9, wherein the data repository is further configured for storing user records.
